(19) United States
(12) Patent Application Publication
(10) Pub. No.: US 2002/0120529 A1
(43) Pub. Date: Aug. 29, 2002

(54) Accelerated access to an electronic catalog

(76) Inventors: Thomas Buettgenbach, San Diego, CA (US); Finbar Sheehy, San Diego, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/055,873

(22) Filed: Jan. 22, 2002

Related U.S. Application Data
(60) Provisional application No. 60/263,347, filed on Jan. 22, 2001.

(51) Int. Cl. G06F 17/60

(52) U.S. Cl. 705/26

(57) ABSTRACT

The invention relates to systems and methods for accelerating a user's access to the contents of an e-commerce Web site. Many consumers access wide area networks through relatively slow connections, such as dial-up connections. Some files, such as images, are relatively large and download relatively slowly to a user computer. The slow connections can make browsing through a merchant's online catalog time-consuming and frustrating. Embodiments of the invention distribute the online catalog between at least the Web server and a Distributed Electronic Catalog Component (DECC), such as a CD-ROM, that can be removably inserted into and out of the user's computer. The DECC and corresponding software detect when data can be extracted from the DECC, rather than merely slowly downloaded over a network. This provides relatively fast access to at least a portion of the online catalog, thereby providing the user with faster access to the online catalog.

### RELATED APPLICATION

This application claims the benefit under 35 U.S.C. §119(e) of U.S. Provisional Application No. 60/263,347, filed Jan. 22, 2001, the entirety of which is hereby incorporated by reference.

### BACKGROUND OF THE INVENTION

1. Field of the Invention

The invention generally relates to computer systems. In particular, the invention relates to acceleration of a user's access to the contents of an online catalog.

2. Description of the Related Art

E-commerce is an evolutionary step of traditional catalog-based retail. Traditional catalog merchants, such as Sears, Land's End, Dean & Deluca, and Victoria's Secret, offer products to a consumer through printed catalogs, which are mailed to the consumer's home. These catalogs allow a consumer to shop from the convenience of home, and periodic updates to a catalog encourage the consumer to leaf through an updated catalog's contents. However, it can be prohibitively expensive to print and to mail glossy, high-production-value catalogs.

One technique used by catalog merchants to avoid the expense of the mass distribution of printed catalogs is limited distribution of the catalogs. Catalog merchants can focus on only the “low-hanging fruit,” i.e., a catalog generally has only a limited number of offerings and the catalogs are mailed primarily to “qualified leads.” Qualified leads include consumers, who are willing to pay for the catalog, and targeted consumers, whose names and addresses can be purchased at relatively great expense from a mailing list. However, this limits the distribution of the catalog to a smaller potential customer base. In addition, catalog merchants should maintain relatively stable offerings and maintain relatively stable prices, since changes can impose the cost of re-printing and re-distributing the catalog. E-commerce changes the catalog business. A catalog that is available online has many advantages over a printed catalog. These advantages include nationwide and even global accessibility to the catalog, a relatively easy to update format, a relatively low distribution cost, a virtually unlimited catalog space, i.e., the catalog can support the sale of a broad number of products, the ability to provide multimedia presentations, such as audio and video presentations, and the convenience of nearly instantaneous and free submission of an order, i.e., no need to fill out and mail a separate order form.

However, online catalogs can also exhibit some disadvantages relative to print catalogs. These disadvantages include a relatively poorer picture quality to maintain a reasonable download time, relatively small pictures to maintain a reasonable download time, and relatively slow page loads when pictures are used. The acuteness of the slowness of a download for a Web page is magnified where a consumer access the online catalog through a relatively slow medium, such as a dial-up modem connection to the Internet. The slowness of access makes it difficult for the consumer to browse through the catalog even when relatively low-quality, small images are used.

### SUMMARY OF THE INVENTION

The invention relates to systems and methods for accelerating a user's access to the contents of an e-commerce Web site and/or an online catalog. Many consumers access wide area networks such as the Internet through relatively slow connections, such as dial-up connections and wireless connections. Some files, such as images, are relatively large and download relatively slowly to a user computer. The slow connections can make browsing through a merchant's online catalog time-consuming and frustrating. Embodiments of the invention distribute the online catalog between at least the Web server and a Distributed Electronic Catalog Component (DECC), such as a CD-ROM, that can be removably inserted into and out of the user's computer. Advantageously, optical disks such as CD-ROMs and DVD-ROMs can be produced in relatively large quantities at relatively little expense. The DECC and corresponding software detect when data can be extracted from the DECC, rather than merely slowly downloaded over a network. This provides relatively fast access to at least a portion of the online catalog, thereby providing the user with the satisfaction of faster access and/or access to a virtual online catalog with relatively large and detailed images.

One embodiment according to the invention is a distributed e-commerce catalog. The distributed e-commerce catalog includes a Distributed Electronic Catalog Component, and a software module adapted to interface with a user's Web browser. A Web page of a product that is offered for sale specifies the inclusion of an image of the product that is to be displayed on the Web page. An image of the product is available for download from the Web server.

The Distributed Electronic Catalog Component is locally accessible by the user computer and can correspond to a read-only-memory (ROM) medium such as a compact-disc read-only-memory (CD-ROM). The Distributed Electronic Catalog Component also includes an image of the product, which can be identical to the image of the product that is downloadable from the Web server, or can be different, such as a higher resolution image or a higher quality image of the product.

The software module intercepts the request for a download of the image and instead, relatively quickly retrieves the image of the product from the Distributed Electronic Catalog Component when the image of the product is available on the Distributed Electronic Catalog Component. The software module provides the image of the product to the Web browser of the user such that the Web browser can display the Web page as intended. This allows the Web page to be displayed in less time than by downloading all of the contents of the Web page from the Web server.

Another embodiment according to the invention is a distributed e-commerce catalog. The distributed e-commerce catalog includes a Web browser, a Distributed Electronic Catalog Component, and a software module that interfaces with the Web browser. The Web browser can communicate with the Web server through, for example, a dial-up Internet connection. The Web browser can display a Web page of a product that is offered for sale, and the Web browser can retrieve a file that is to be included in the Web page from a Web server. The Distributed Electronic Catalog Component is locally accessible by the user computer and corresponds to a read-only-memory (ROM) such as a CD-ROM. The Distributed Electronic Catalog Component includes data that corresponds to data that is present on the remote Web server. The Web browser is configured to display Web pages to the user. The software module is adapted to interface with the Web browser and to intercept a request from the Web browser to the Web server for the file such that the request is not sent to the Web server when the file is available on the Distributed Electronic Catalog Component. The software module is configured to retrieve the file relatively quickly from the Distributed Electronic Catalog Component rather than download the file over a relatively slow connection from the Web browser, and the software module is configured to provide the file to the Web browser.

Another embodiment according to the invention is a computer program embodied in a tangible medium. The computer program can be implemented as a plug-in to a Web browser. The computer program includes a first module that is configured to monitor a content that is intended to be loaded onto a Web page viewable by a user. A second module is configured to determine whether the content is locally available from a Distributed Electronic Catalog Component. A third module is configured to retrieve the content from the Distributed Electronic Catalog Component if the content is available on the Distributed Electronic Catalog Component. The computer program also includes a fourth module is configured to retrieve the content from a remote Web server if the content is not available on the Distributed Electronic Catalog Component.

One embodiment according to the invention is a system that accelerates access to the contents of an e-commerce Web site and/or an online catalog. The system includes a Distributed Electronic Catalog Component that is provided to a user computer and is pre-loaded with content that is also available from the e-commerce Web site. The system further includes an Internet connection, such as a dial-up connection, that allows the user computer to communicate with the e-commerce Web site. The system also includes a means for monitoring a Web browser in the user computer for a request for content from the e-commerce Web site, and a means for determining whether the requested content is present on the Distributed Electronic Catalog Component. In addition, the system includes a means for intercepting the request to the e-commerce Web site for the content such that the request is not sent to the e-commerce Web site and a means for locally retrieving the content from the Distributed Electronic Catalog Component, which are activated when the requested content is present on the Distributed Electronic Catalog Component. When the requested content is not present on the Distributed Electronic Catalog Component, a means for allowing the request for the content to proceed to the e-commerce Web site and a means for remotely retrieving the content from the e-commerce Web site are activated. The system further includes a means for providing the retrieved content to the Web browser. In one embodiment, the system determines whether the content is present on the Distributed Electronic Catalog Component by comparing a uniform resource locator (URL) for the requested content to a URL stored in the Distributed Electronic Catalog Component.

Another embodiment according to the invention is a system that accelerates access to the contents of an e-commerce Web site that is remote from a user computer such as an automated shopping kiosk. A user computer with a slow connection to the Internet, such as a dial-up Internet connection, can retrieve a portion of a Web page's data from a removable Distributed Electronic Catalog Component that is present in the user computer. The Distributed Electronic Catalog Component can include a read-only-memory medium such as a CD-ROM. The Distributed Electronic Catalog Component is pre-loaded with content that can be retrieved in lieu of downloading the content from the e-commerce Web site. The system includes a means for receiving a source code for a Web page from the e-commerce Web site and a means for evaluating the source code for the Web page for content that is to be retrieved from a remote Web site. A means for retrieving content from the Distributed Electronic Catalog Component retrieves content from the Distributed Electronic Catalog Component when the content is available from the Distributed Electronic Catalog Component. A means for retrieving the content from a remote Web site retrieves content from a remote Web site such as the e-commerce Web site when the requested content is not present on the Distributed Electronic Catalog Component. The system further includes a means for displaying the Web page with the retrieved content and a means for using the Web page to make a purchase.

One embodiment according to the invention is a process for accelerating access to the contents of an e-commerce Web site and/or an online catalog. The process includes providing a Distributed Electronic Catalog Component to a user computer, where the Distributed Electronic Catalog Component is pre-loaded with content that is also available from the e-commerce Web site, where the e-commerce Web site is accessible to the user computer through an Internet connection, monitoring a Web browser in the user computer for a request for content, where the request is intended to be sent to the e-commerce Web site, delaying the request for content, and determining whether the requested content is present on the Distributed Electronic Catalog Component. The process further includes intercepting the request to the e-commerce Web site for the content such that the request is not sent to the e-commerce Web site and retrieving the content from the Distributed Electronic Catalog Component if the requested content is present on the Distributed Electronic Catalog Component. The process further includes allowing the request for the content to proceed to the e-commerce Web site and retrieving the content from the e-commerce Web site if the requested content is not present on the Distributed Electronic Catalog Component and providing the retrieved content to the Web browser. One embodiment of the process determines whether the content is present on the Distributed Electronic Catalog Component by comparing a uniform resource locator (URL) for the requested content to a URL stored in the Distributed Electronic Catalog Component. In one embodiment, the Internet connection includes a dial-up phone modem. In one embodiment, the Distributed Electronic Catalog Component includes an optical disk.

Another embodiment according to the invention is a process for accelerating access to an e-commerce Web site that is remote from a user computer. The process includes providing a Distributed Electronic Catalog Component to the user computer, where the Distributed Electronic Catalog Component is pre-loaded with content that is also available from the e-commerce Web site, receiving a source code for a Web page from the e-commerce Web site, evaluating the source code for the Web page for content that is to be retrieved from a remote Web site including from the e-commerce Web site, retrieving content from the Distributed Electronic Catalog Component if the content is available from the Distributed Electronic Catalog Component, retrieving the content from the remote Web site if the requested content is not present on the Distributed Electronic Catalog Component, displaying the Web page with the content, and using the Web page to make a purchase. In one embodiment of the process, the Distributed Electronic Catalog Component corresponds to a type of read only memory (ROM). In one arrangement, the user computer communicates with a remote Web site with a dial-up Internet connection.

### BRIEF DESCRIPTION OF THE DRAWINGS

These and other features of the invention will now be described with reference to the drawings summarized below. These drawings and the associated description are provided to illustrate preferred embodiments of the invention and are not intended to limit the scope of the invention.

FIG. 1 illustrates an integrated distributed electronic catalog system in accordance with one embodiment of the invention.

FIG. 2 illustrates system states of an exemplary process performed by the integrated distributed electronic catalog system illustrated in FIG. 1.

FIG. 3 illustrates another embodiment of an integrated distributed electronic catalog system according to the invention.

### DETAILED DESCRIPTION OF THE PREFERRED EMBODIMENTS

Although this invention will be described in terms of certain preferred embodiments, other embodiments that are apparent to those of ordinary skill in the art, including embodiments which do not provide all of the benefits and features set forth herein, are also within the scope of this invention. Accordingly, the scope of the invention is defined only by reference to the appended claims.

Embodiments of the invention include systems and methods that augment an online catalog by distributing key data and specialized software on low-cost storage media. The systems and methods described herein provide a user or consumer, who would otherwise have relatively slow access to a merchant's online catalog, with relatively fast apparent access to the merchant's online catalog. The user or consumer is provided with a Distributed Electronic Catalog Component (“DECC”), which can correspond to an optical disk such as a Compact-Disk Read-Only-Memory (“CD-ROM”) or some other relatively low-cost, high-density removable storage media. The DECC can be pre-loaded with content of key catalog data and specialized software, and can be supplemented with data provided over a network, such as the Internet. In one embodiment, the DECC is a computer addressable read-only-memory (ROM). Another example of a suitable storage media for the DECC is a DVD-ROM.

Because of the lower cost of publication of catalog information with CD-ROM relative to printed catalog distribution, a lower level of “qualification” can justify the cost of distribution to a user. This approach therefore advantageously enables wider distribution of the CD-ROM catalog for the same cost than is the case with printed catalogs. At the same time, the addition of technologically-enabled marketing tools from sources such as opt-in emails and multimedia presentations can increase the conversion rate from catalogs to sales.

One embodiment according to the invention includes two central elements: key data, which is distributed on relatively low-cost storage media, and specialized software. Key data refers to data-intensive portions of a catalog, which are distributed to potential customers on the CD-ROMs. While illustrated in the context of image files, the skilled artisan will appreciate that the principles and advantages described herein are applicable to other types of data-intensive portions of a catalog including sound files, static images such as pictures, moving images such as videos and animations, and the like. Examples of animation include Macromedia Flashy and Macromedia Shockwave™ from Macromedia, Inc.

The availability of data-intensive portions of the catalog on a CD-ROM allows a customer to quickly access the data-intensive portions of the catalog without the frustrating wait of the downloading of the data-intensive portions over a relatively slow network connection. In one embodiment, the network connection includes a connection to the Internet. Typically, in exchange for a monthly fee, an ISP provides access to the Internet. The access can be via many mediums including modems on phone lines, satellite communications, wireless modems, cable modems, DSL, etc.

The computers described herein may be any microprocessor or processor (hereinafter referred to as processor) controlled device, including, but not limited to a terminal device, such as a personal computer, a workstation, a server, a client, a mini computer, a main-frame computer, a laptop computer, a network of individual computers, a mobile computer, a palm top computer, a hand held computer, a set top box for a TV, an interactive television, an interactive kiosk such as a kiosk configured for online shopping, a personal digital assistant, an interactive wireless communications device, a mobile browser, or a combination thereof. The computer may further possess input devices such as a keyboard, a mouse, a trackball, a touch pad, or a touch screen, and output devices such as a computer screen, printer, speaker, or other input devices now in existence or later developed.

The system further enables the customer to access current price and availability information, to place orders, and to access other products not included in the distributed CD-ROM catalog, such as new additions to the catalog, over the Internet. The specialized software distributed with the data provides for integration and coordination of the data contained on the CD-ROM with the online catalog accessed over the Internet. By enabling this integration, the specialized software offers greater flexibility to the catalog merchant in the structuring and location of the data and in the functionality offered than is the case with either an online-only catalog or a CD-ROM only based catalog.

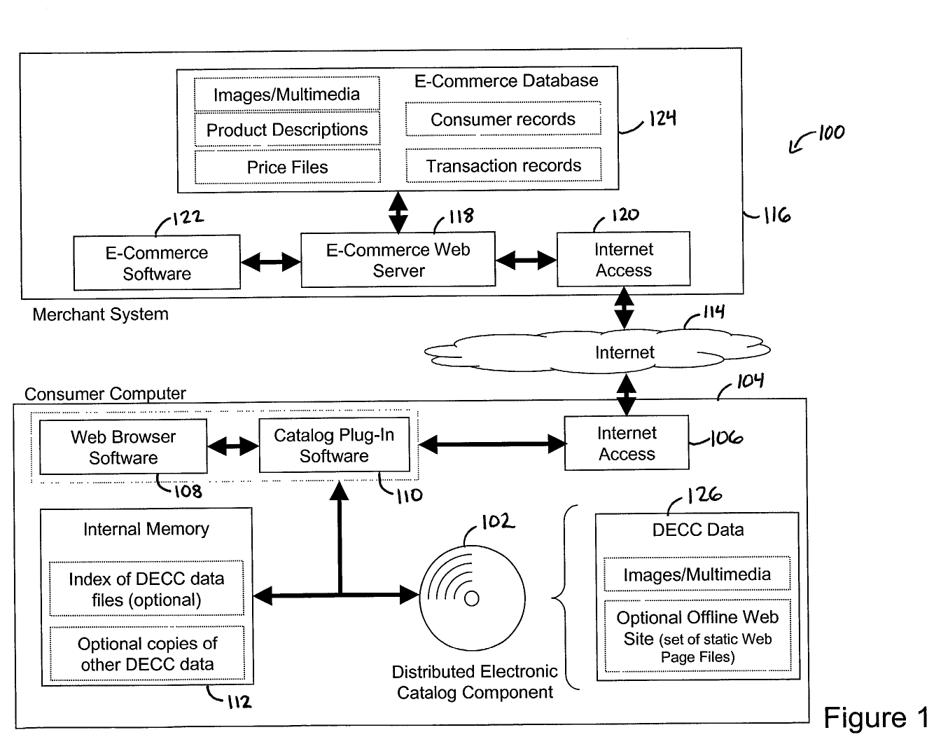

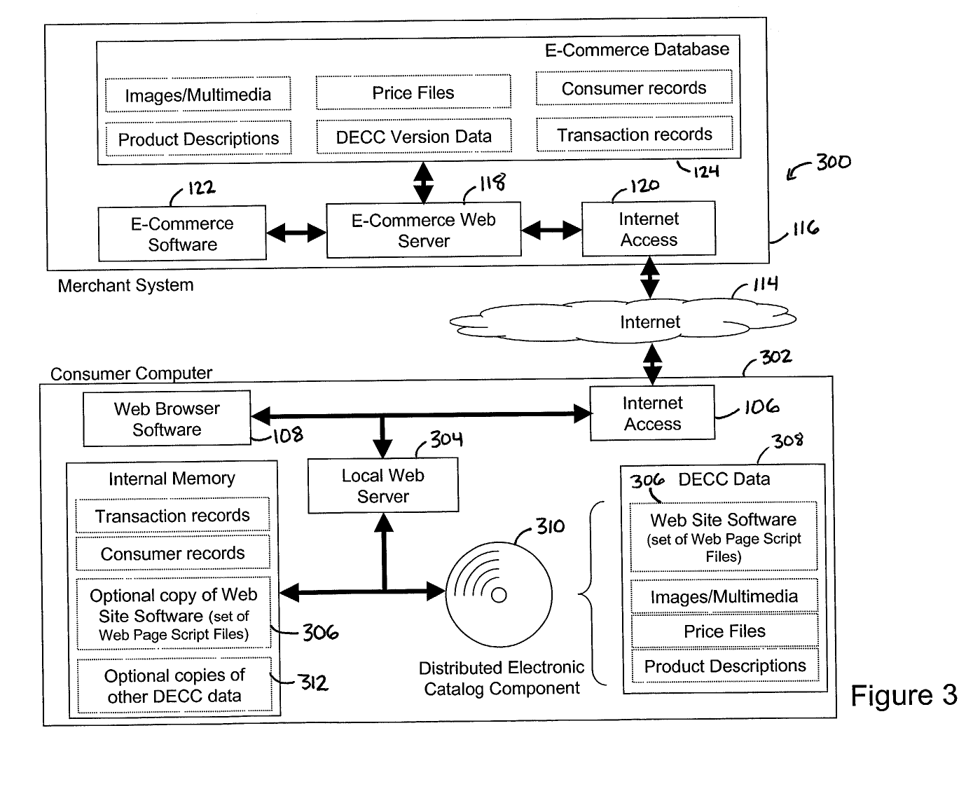

FIG. 1 illustrates an integrated distributed electronic catalog system 100 in accordance with one embodiment of the invention. Other embodiments, which may include other benefits and features than those of the illustrated embodiment, are also described below and later in connection with FIG. 3.

A Distributed Electronic Catalog Component (“DECC”) 102 contains the data-intensive parts of the catalog, i.e., is pre-loaded with portions of the catalog. The DECC 102 is shown in FIG. 1 as a CD-ROM, but in other embodiments can correspond to other forms of removable storage mediums. The DECC 102 is inserted into a consumer computer 104 or user computer that includes an Internet access 106, a Web Browser (“Browser”) 108, and specialized software referred to as a Catalog Plug-In Software 110. In one embodiment, the Internet access 106 corresponds to a dial-up modem. In one embodiment, the consumer computer 104 corresponds to a laptop computer and the Internet access 106 corresponds to a wireless modem. Of course, the contents of the DECC 102 can be provided in compressed or uncompressed form, and can additionally be copied onto a local mass memory device 112 such as a disk drive.

Preferably, the code for the Catalog Plug-In Software 110 is conveniently distributed with the DECC 102 itself, thereby allowing a consumer to install the Catalog Plug-In Software 110 on the consumer computer 104. In one embodiment, the code for the Catalog Plug-In Software 110 is downloaded from a Web site via the Internet 114, which can be useful where the amount of data to be stored on the DECC is approaching the capacity of the storage medium or where the Catalog Plug-In Software 110 has already been distributed to the particular consumer. In another embodiment, the code for the Catalog Plug-In Software 10 is preinstalled on the consumer computer 104.

In one embodiment, the Catalog Plug-In Software 110 operates as a “plu-in” to the Browser 108, i.e., the Catalog Plug-In Software 110 operates closely with and in parallel with the Browser 108 and is integrated with the Browser 108 via Application Programming Interfaces (APIs). The Browser 108 is an application, which can locate and display Web pages. Standard Browsers include the Netscape® Navigator developed by Netscape, Inc. and the Microsoft® Internet Explorer developed by Microsoft Corporation.

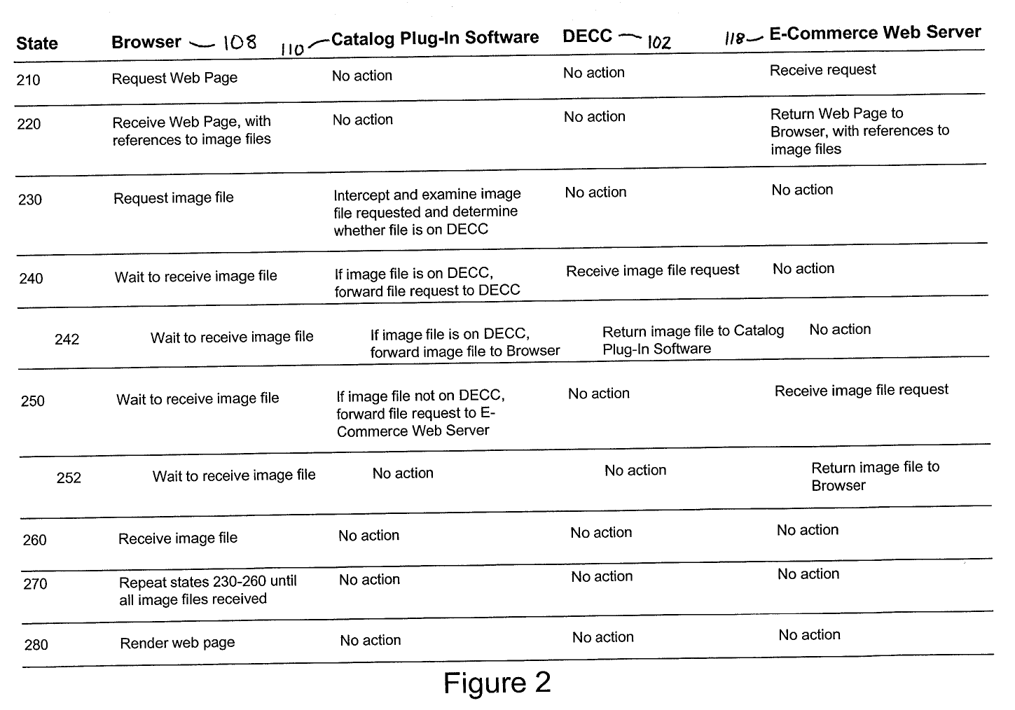

The integrated distributed electronic catalog system 100 includes a merchant system 116. The merchant system 116 includes an e-commerce Web Server 118, which can serve a variety of Web pages that are related to e-commerce, and includes an Internet Access 120 to communicate with the consumer computer 104 via the Internet 114. The merchant system further includes an e-commerce Software 122 to process transactions and the like, and further includes an e-commerce Database 124 that stores and maintains account and inventory information. It will be understood by one of ordinary skill in the art that the e-commerce Database 124 can correspond to multiple databases, which are not necessarily housed in the same data store and can be located in geographically disparate locations. In the illustrated embodiment, the e-commerce Web Server 118 communicates with the e-commerce Software 122 and with the e-commerce Database 124. The skilled practitioner will appreciate that other configurations are possible. For example, in another embodiment, the e-commerce Web Server 118 communicates with the e-commerce Software 122, and the e-commerce Software 122 communicates with the e-commerce Database 124. In one embodiment, the merchant system 116 corresponds to a conventional merchant system, and the operation of the DECC 102 and the Catalog Plug-In Software 110 is transparent to the merchant system 116. Further details of the interaction within the merchant system 116 are described later in connection with FIG. 2.

FIG. 2 illustrates system states of an exemplary process performed 200 by various modules of the integrated distributed electronic catalog system 100 described in connection with FIG. 1. As shown in FIG. 2, when a consumer shops with a merchant associated with the merchant system 116, the consumer computer 104 is connected to the Internet 114. In a first state 210, the consumer directs the Browser 108 to a Web page on the e-commerce Web Server 118. The consumer can direct the Browser 108 by typing in a uniform resource locator (URL), by selecting a hyperlink, and the like. The general format of the URL is “protocol://machineaddress/path/filename.” The e-commerce Web Server 118 receives the request for the Web page. The process advances from the first state 210 to a second state 220.

In the second state 220, the e-commerce Web Server 118 retrieves the corresponding file for the selected Web page and sends the Web page to the Browser 108 of the Consumer Computer 104. Examples of the corresponding data for the selected Web page include hypertext markup language (HTML) code, extensible markup language (XML) code, and the like. The requested Web page file contains layout information and can further contain the names or URLs of multiple image files that are to be embedded in the page. The process advances from the second state 220 to a third state 230.

In a conventional system, the Browser 108 requests each of these image files in turn from the e-commerce Web Server 118, and completes display of the Web page upon receipt of these image files. By contrast, the Catalog Plug-In Software 110 operates in a more efficient manner.

In the third state 230, the Browser interprets the file or code for the selected Web page and requests the image files, to display the Web page as intended. The Catalog Plug-In Software 110 intercepts the requests for the image files and determines whether corresponding image files are present in the DECC 102. Operating in conjunction with the Browser 108, the Catalog Plug-In Software 110 identifies the image file names and where the DECC 102 is present in the consumer computer 104, the Catalog Plug-In Software 110 searches a DECC database 126 for corresponding image files to determine whether they are available on the DECC 102. In one embodiment, the Catalog Plug-In Software 110 searches the DECC 102 directly. In another embodiment, the Catalog Plug-In Software 110 creates an index of DECC files in the consumer computer 104 for more rapid search and access.

If the DECC 102 maintains the image files, the process proceeds from the third state 230 to a fourth state 240. If the DECC 102 does not maintain a requested image file, the process proceeds from the third state 230 to a sixth state 250.

In the fourth state 240, the Catalog Plug-In Software 110 requests a corresponding image file from the DECC 102. The process advances from the fourth state 240 to a fifth state 242, where the image file is retrieved from the DECC 102 and provided to the Catalog Plug-In Software 110. When an image file is available from the DECC 102, it is loaded from the DECC 102 or from a local copy of the DECC 102. The Catalog Plug-In Software 110 supplies the Browser 108 with the image files from the DECC 102, so that those image files need not be transferred over the Internet 114 from the e-commerce Web Server 118. This advantageously speeds the display of the image files. In another embodiment, the image file is provided directly to the Browser 108. The process advances from the fifth state 242 to an eighth state 260.

In the sixth state 250, the Catalog Plug-In Software 110 forwards the request for the image file from the e-commerce Web Server 118. If the DECC 102 is not loaded or the image file is not otherwise available on the DECC 102, the image file is downloaded from the e-commerce Web Server 118 in a conventional manner. Operation of the Catalog Plug-In Software 110 is transparent to the user. The process advances from the from the sixth state 250 to a seventh state 252, where the e-commerce Web Server 118 sends the requested image file to the Browser 108 in response to the request for the image file. The process advances from the from the seventh state 252 to the eighth state 260.

In the eighth state 260, the Browser 108 receives the requested image file. The process advances from the eighth state 260 to a ninth state 270, where the process returns to the appropriate states of the third state 230, the fourth state 240, the fifth state 242, the sixth state 250, the seventh state 252, and the eighth state 260 until the image files for the Web page have been retrieved. The process advances from the ninth state 270 to a tenth state 280, where the Browser 108 renders the Web page. It will be understood by one of ordinary skill in the art that in another embodiment, the Browser 108 renders the Web page as the image files are retrieved.

One embodiment according to the invention includes a method of enabling the Catalog Plug-In Software 110 to avoid searching for selected files in the DECC 102, thereby speeding up search time for other files. When the Catalog Plug-In Software 110 is searching its database for an image file, the overall operation of the Browser 108 can slow down as the CPU of the Consumer Computer multitasks. One method allows the Catalog Plug-In Software 110 to avoid searching for files by designating specified file extensions to files that are or are not locally stored. For example, image files can be named in accordance with a filename convention that signifies that there can be a locally stored copy of the image and which provides date-of-creation information or alternatively version information. In this way, the Catalog Plug-In Software 110 is alerted to the existence of a local copy of the image file on the DECC 102. The Catalog Plug-In Software 110 is also able to check whether the image that is sought is old enough that it should be on the DECC 102, i.e., if the image file was created more recently than a creation date of the DECC 102, the file should be obtained from the e-commerce Web Server 118.

Of course, a variety of methods are possible for alerting the Catalog PlugIn Software 110 to the existence of a local copy of the image file and for determining whether that copy is actually stored locally or is to be retrieved from the e-commerce Web Server 118 via the Internet 114. A second example relies on the Catalog Plug-In Software 110 to recognize that the request is sent to a particular Web site, and that the DECC 102 that is present in the consumer computer 104 corresponds to the Web site. In one embodiment, the Catalog Plug-In Software 110 then searches for the images on the DECC 102, irrespective of the creation date of the image file. In this case, when the DECC 102 is created, it is created with a relatively large set of image filenames including existing images and placeholders for images to be included in future catalogs. Where the images already exist, they are stored on the DECC 102. Where the filename is a placeholder for a future image, the file stored on the DECC 102 contains a redirect instruction to the Catalog Plug-In Software 110 to request the image from the e-commerce Web Server 118 over the Internet 114. As subsequent iterations of the DECC 102 are published, actual images replace redirect instructions. Consumers using a newer version of the DECC 102 experience that relatively more images load from the DECC 102 itself, while those consumers using an older version of the DECC 102 experience that relatively more of their images are downloaded over the Internet 114.

One embodiment of the system can be used to offer a “basic” level of image quality to general users over the Internet 114, with “enhanced” image quality available to users who have access to the DECC 102. In one example, an image provided by the e-commerce Web Server 118 can be miniaturized by reducing image quality or reducing picture size so that a user with a relatively slow connection will not have to wait a relatively long time for the image to download. However, a user can be provided with a relatively high quality image and/or relatively large image by storing the corresponding image on the DECC 102. Alternatively, the image stored on the e-commerce Web Server 118 can include text with a message “High-Quality Image Available Only from our CD-ROM Catalog,” or the like, while the image stored on the DECC 102 (in this example, a CD-ROM) can be the highquality image. In one embodiment, conventional e-commerce catalog or online store practices are used in connection with other aspects of the interaction between the consumer and the merchant, such as, procedures to place an order.

An alternative embodiment of the invention will now be described. The alternative embodiment is similar to the embodiment described in connection with FIG. 1, except that the Catalog Plug-In Software 110 includes at least two operating modes: a first mode for when the consumer computer 104 has an active connection to the Internet 114, i.e., the “online mode,” and a second mode for when the consumer computer 104 does not have an active connection to the Internet 114, i.e., the “offline mode.”

When the Catalog Plug-In Software 110 is operated in the offline mode, the Catalog Plug-In Software 110 determines whether the Browser 108 is requesting data from a recognized domain name, such as a recognized Uniform Resource Locator (URL). If so, the Catalog Plug-In Software 110 intercepts this request and returns a “redirect” file that redirects the Browser 108 to a Web page file stored on the DECC 102. This Web page file can in turn contain hyperlinks to other Web page files stored on the DECC 102 so that the merchant can offer an “offline” catalog or “Web site” that the consumer can browse while the consumer computer 104 is not connected to the Internet 114.

FIG. 3 illustrates another embodiment of an integrated distributed electronic catalog system 300 according to the invention. The embodiment illustrated in FIG. 3 offers more sophisticated capabilities than the embodiments described in connection with FIGS. 1 and 2. In the illustrated embodiment, a consumer computer 302 includes more sophisticated software that replaces the Catalog Plug-In Software 110 described earlier in connection with FIGS. 1 and 2. The more sophisticated software includes a Local Web Server 304 and a Web Site Software 306. The Web Site Software 306 includes a series of Web Page Script Files, which the Local Web Server 304 interprets to create Web page files. Preferably, the software for the Local Web Server 304 and the Web Site Software 306 is included with the data 308 stored on a DECC 310, but the software can also be provided in other ways, such as by download via the Internet 114.

When a consumer wishes to shop with a merchant, the consumer directs the Browser 108 to request a Web page file from the Local Web Server 304. The Local Web Server 304 retrieves the appropriate Web Page Script File from the DECC 310 or other storage in a consumer computer's memory 312 and interprets the Script File to create a Web page file, which it returns to the Browser 108 for display.

Advantageously, the method described above allows a dynamic online/offline catalog/Web site (“dynamic Web site”) to be stored on the DECC 310. The dynamic Web site creates Web pages for display in real time based on the content of the Web Page Script Files. The dynamic Web site can create each Web page for display based on the availability of Web page files, image files, and other data files from the e-commerce Web Server 118 and/or the DECC 310.

Where the consumer computer 302 maintains an active Internet connection, i.e., is “online,” the Web Page Script File directs the Local Web Server 304 to fetch Web pages from the e-commerce Web Server 118 over the Internet 114, while fetching available data-intensive elements, such as image files, from locally available storage such as the DECC 310 or the consumer computer's memory 312.

The illustrated embodiment of FIG. 3 is similar to the embodiments described in connection with FIG. 1 and the alternative embodiment described after the description of FIG. 1, in that image files are fetched from the DECC 310 if they are stored there, and otherwise are fetched from the e-commerce Web Server 118 via the Internet 114. In the illustrated embodiment, the Web Page Script File directs the Local Web Server 304 to fetch the main Web page from the e-commerce Web Server 118 over the Internet 114 so that the Local Web Server 304 includes additional data with the request to the e-commerce Web Server 118. This additional data includes information on the creation date or version number of the DECC 310 and on a local file/path information needed for the Browser 108 to recover files from the DECC 310 the file/path data is captured or generated during the initial installation of the DECC 310 on the consumer computer 302.

Further, the e-commerce Web Server 118 generates Web page files that direct the Browser 108 to recover image files (or any other files, including Web page files, Web Page Script Files, multimedia files, etc.) from the DECC 310, where possible. Where the required files are not on the DECC 310, the e-commerce Web Server 118 uses the creation date/version number of the DECC 310 to detect the absence of the desired files and instructs the Browser to recover those files from the e-commerce Web Server 118 itself. The illustrated embodiment advantageously provides relatively great flexibility because it is more easily updated or reconfigured by changing the programming of the e-commerce Web Server 118.

Where the consumer computer 302 does not have an active Internet connection, i.e., is “offline,” one embodiment of the Local Web Server 304 is entirely controlled by Web Page Script Files stored on the DECC 310. These files enable the integrated distributed electronic catalog system 300 to offer full e-commerce capability, with dynamically-generated Web pages that respond to consumer inputs, and with the ability to store order forms, “cookies,” and other consumer-input or process-related data, such as consumer orders, consumer preferences, consumer purchasing record, on the consumer computer 302 for later upload to the e-commerce Web Server 118 when the consumer computer is again online or for future use in the “offline” mode.

The following example illustrates advantages of the flexibility provided by the embodiment illustrated in FIG. 3. A traveling salesman, equipped with the consumer computer 302, such as a portable computer, uses the offline mode with the Web Site Software 306 and image/data files stored on the DECC 310 to show a range of products to a potential buyer. In one example, the details shown on portable computer's screen reveal that the information is “accurate or current as of [X date]” so that the buyer and the salesman are aware that prices are recent but not necessarily current. The buyer indicates interest in purchasing several products, but indicates that, if the prices have risen by more than 5%, the buyer should be informed before proceeding with the transaction. The salesman stores all this information on the consumer computer 302 using the Web Site Software 306. Either at the end of the discussion, or at a later time, the salesman connects the computer to the Internet 114 and communicates the order form to the e-commerce Web Server 118, which responds with an order confirmation. At this time, prices and availability are updated to the current status, so that the final decision and transaction can be completed.

A second example shows how a consumer who uses the DECC 310 for the merchant receives a higher level of online catalog service from the merchant than does a consumer who is merely using a standard Browser. The e-commerce Web Server 118 corresponding to the merchant, where informed by the Local Web Server 304 that the consumer computer 302 is equipped with the DECC 310, the Local Web Server 304 and the Web Site Software 306, can serve an enhanced version of the standard Web page file, which can include links to high-resolution images, multimedia presentations and data files stored on the DECC 310. This enables the consumer with the DECC 310 to examine a product more closely, to see it in use in a multimedia presentation, and/or to receive more complete specifications on the product. A consumer who does not have the DECC 310 and associated software receives only the standard Web page file, which does not include the links to more information.

Various embodiments of the invention have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

What is claimed is:

1. A distributed e-commerce catalog comprising:
a Distributed Electronic Catalog Component that is locally accessible by a user computer, where the Distributed Electronic Catalog Component corresponds to a read-only-memory (ROM) and includes a first image of a product; and
a software module adapted to interface with a Web browser of the user computer, where the software module is configured to intercept a request from the Web browser to a Web server for a second image of the product that is intended to be included in a Web page of the product such that the request is not sent to the Web server when the first image of the product is available on the Distributed Electronic Catalog Component, and where the software module is further configured to retrieve the first image of the product from the Distributed Electronic Catalog Component and is configured to provide the first image of the product to the Web browser of the user computer such that the Web browser can display the Web page as intended.

2. The distributed e-commerce catalog as defined in claim 1, where the Distributed Electronic Catalog Component is stored on a compact-disc read-only-memory (CD-ROM).

3. The distributed e-commerce catalog as defined in claim 1, where the first image and the second image are identical files.

4. The distributed e-commerce catalog as defined in claim 1, where the first image and the second image depict the same product, but the first image is a larger file than the second image such that the first image is of higher quality.

5. A distributed e-commerce catalog comprising:
a Web browser adapted to communicate with a Web server and to display Web pages to a user including a Web page of a product that is offered for sale, where the Web page specifies inclusion of a file that is available for download from the Web server;
a Distributed Electronic Catalog Component that is locally accessible by a user computer, where the Distributed Electronic Catalog Component corresponds to a read-only-memory (ROM) and includes the file;
a software module adapted to interface with the Web browser, where the software module is configured to intercept a request from the Web browser to the Web server for the file such that the request is not sent to the Web server when the file is available on the Distributed Electronic Catalog Component, and where the software module is further configured to retrieve the file from the Distributed Electronic Catalog Component and configured to provide the file to the Web browser of the user.

6. The distributed e-commerce catalog as defined in claim 5, wherein the file corresponds to a multimedia presentation.

7. The distributed e-commerce catalog as defined in claim 5, wherein the communication between the Web browser and the Web server includes a dial-up connection.

8. A computer program embodied in a tangible medium comprising:
a first module adapted to monitor a request for a content that is intended to be loaded onto a Web page viewable by a user;
a second module adapted to determine whether the requested content is locally available from a Distributed Electronic Catalog Component, where the Distributed Electronic Catalog Component is an optical disk;
a third module adapted to retrieve the content from the Distributed Electronic Catalog Component if the content is available on the Distributed Electronic Catalog Component; and
a fourth module adapted to retrieve the content from a remote Web server if the content is not available on the Distributed Electronic Catalog Component.

9. The computer program as defined in claim 8, wherein at least a portion of the computer program is implemented as a plug-in to a Web browser.

10. A system that accelerates access to an e-commerce Web site comprising:
a Distributed Electronic Catalog Component that is provided to a user computer, where the Distributed Electronic Catalog Component is pre-loaded with content that is also available from the e-commerce Web site;
an Internet connection that allows the user computer to communicate with the e-commerce Web site;
a means for monitoring a Web browser in the user computer for a request for content, where the request is intended to be sent to the e-commerce Web site;
a means for determining whether the requested content is present on the Distributed Electronic Catalog Component;
a means for intercepting the request to the e-commerce Web site for the content such that the request is not sent to the e-commerce Web site, where the means for intercepting is activated when the requested content is present on the Distributed Electronic Catalog Component;
a means for locally retrieving the content from the Distributed Electronic Catalog Component, where the means for locally retrieving is activated when the requested content is present on the Distributed Electronic Catalog Component;
a means for allowing the request for the content to proceed to the e-commerce Web site where the means for allowing is activated when the requested content is not present on the Distributed Electronic Catalog Component;
a means for remotely retrieving the content from the e-commerce Web site, where the means for remotely retrieving is activated when the requested content is not present on the Distributed Electronic Catalog Component; and
a means for providing the retrieved content to the Web browser.

11. The system as defined in claim 10, wherein the system determines whether the content is present on the Distributed Electronic Catalog Component by comparing a uniform resource locator (URL) for the requested content to a URL stored in the Distributed Electronic Catalog Component.

12. The system as defined in claim 10, wherein the Internet connection comprises a dial-up phone modem.

13. The system as defined in claim 10, wherein the Internet connection comprises a wireless modem.

14. The system as defined in claim 10, wherein the Distributed Electronic Catalog Component comprises an optical disk.

15. A system that accelerates access to an e-commerce Web site that is remote from a user computer, the system comprising:
a removable Distributed Electronic Catalog Component in a user computer, where the Distributed Electronic Catalog Component is pre-loaded with content that is also available from the e-commerce Web site;
an Internet connection that allows the user computer to communicate with the e-commerce Web site;
a means for receiving a source code for a Web page from the e-commerce Web site;
a means for evaluating the source code for the Web page for content that is to be retrieved from a remote Web site including from the e-commerce Web site;
a means for retrieving content from the Distributed Electronic Catalog Component, wherein the means for retrieving is active when the content is available from the Distributed Electronic Catalog Component;
a means for retrieving the content from the remote Web site, where the means for retrieving is active when the requested content is not present on the Distributed Electronic Catalog Component;
a means for displaying the Web page with the retrieved content; and
a means for using the Web page to make a purchase.

16. The system as defined in claim 15, wherein the Distributed Electronic Catalog Component corresponds to a type of read only memory (ROM).

17. The system as defined in claim 15, wherein the Internet connection comprises a dial-up Internet connection.

18. A process for accelerating access to an e-commerce Web site comprising:
providing a Distributed Electronic Catalog Component to a user computer, where the Distributed Electronic Catalog Component is pre-loaded with content that is also available from the e-commerce Web site, where the e-commerce Web site is accessible to the user computer through an Internet connection;
monitoring a Web browser in the user computer for a request for content, where the request is intended to be sent to the e-commerce Web site;
delaying the request for content;
determining whether the requested content is present on the Distributed Electronic Catalog Component;
intercepting the request to the e-commerce Web site for the content such that the request is not sent to the e-commerce Web site and retrieving the content from the Distributed Electronic Catalog Component if the requested content is present on the Distributed Electronic Catalog Component;
allowing the request for the content to proceed to the e-commerce Web site and retrieving the content from the e-commerce Web site if the requested content is not present on the Distributed Electronic Catalog Component; and
providing the retrieved content to the Web browser.

19. The process as defined in claim 18, wherein the process determines whether the content is present on the Distributed Electronic Catalog Component by comparing a uniform resource locator (URL) for the requested content to a URL stored in the Distributed Electronic Catalog Component.

20. The process as defined in claim 18, wherein the Internet connection comprises a dial-up phone modem.

21. The process as defined in claim 18, wherein the Distributed Electronic Catalog Component comprises an optical disk.

22. A process for accelerating access to an e-commerce Web site that is remote from a user computer, the process comprising:
providing a Distributed Electronic Catalog Component to the user computer, where the Distributed Electronic Catalog Component is pre-loaded with content that is also available from the e-commerce Web site;
receiving a source code for a Web page from the e-commerce Web site;
evaluating the source code for the Web page for content that is to be retrieved from a remote Web site including from the e-commerce Web site;
retrieving content from the Distributed Electronic Catalog Component if the content is available from the Distributed Electronic Catalog Component;
retrieving the content from the remote Web site if the requested content is not present on the Distributed Electronic Catalog Component;
displaying the Web page with the content; and
using the Web page to make a purchase.

23. The process as defined in claim 22, wherein the Distributed Electronic Catalog Component corresponds to a type of read only memory (ROM).

24. The process as defined in claim 22, wherein the user computer communicates with a remote Web site with a dial-up Internet connection.

25. A process of selecting content to be served from an e-commerce Web site to a user computer, the process comprising:
communicating with the user computer;
receiving an indication of whether a Distributed Electronic Catalog Component is available in the user computer;
providing a first content to the user computer when the Distributed Electronic Catalog Component is available in the user computer; and
providing a second content to the user computer when the Distributed Electronic Catalog Component is not available in the user computer.

26. The process as defined in claim 25, wherein the first content and the second content vary in a price of a product.
